(19) United States
(12) Patent Application Publication
(10) Pub. No.: US 2013/0222102 A1
(43) Pub. Date: Aug. 29, 2013

(54) METHOD OF PRODUCTION OF IGNITION COIL AND IGNITION COIL PRODUCED BY THAT METHOD OF PRODUCTION

(71) Applicant: DENSO CORPORATION, (US)

(72) Inventors: Tatsunori MAKISHIMA, Okazaki-city (JP); Takashi AOKI, Toyoake-city (JP)

(73) Assignee: DENSO CORPORATION, KARIYA-CITY, AICHI-PREF (JP)

(21) Appl. No.: 13/673,364

(22) Filed: Nov. 9, 2012

(30) Foreign Application Priority Data
Feb. 24, 2012 (JP) 2012-038617

(51) Int. Cl. H01F 41/04; H01F 27/32

(52) U.S. Cl. CPC H01F 41/04; H01F 27/327
USPC 336/96; 29/602.1

(57) ABSTRACT

A method of production of an ignition coil which provided with a core so as to form a mold release film which enables reduction of the adhesion with an epoxy resin comprising using a metal to form a rod-shaped center core, dipping the formed center core in a liquid UV curing resin, raising the center core from the liquid and shaking off the excess UV curing resin, irradiating the center core with UV rays to cause the UV curing resin which is deposited on the center core to cure and form an insulating film, attaching a first spool to the outside of the insulating film and winding a secondary coil over it, attaching a second spool to the outside of the secondary coil and winding a primary coil over it, inserting these into a case, then injecting an insulating material into the case to thereby produce an ignition coil.

### BACKGROUND OF THE INVENTION

1. Field of the Invention

The present invention relates to a method of production of an ignition coil and an ignition coil which is produced by that method of production.

2. Description of the Related Art

In a vehicle which mounts a gasoline engine, gasoline which is injected into a cylinder is ignited by a spark plug. For this, an ignition system which uses an ignition coil is used. The ignition coil acts to convert low voltage of a battery to a high voltage so that a spark is generated at the spark plug. Such an ignition coil is configured by a core comprised of a stack of iron sheets with a large magnetic permeability at its center (hereinafter referred to simply as a “core”) around which a primary coil and a secondary coil are wound.

As one technique for reduction of size and increase of output of the ignition coil, there is the art of direct winding around the center core. The advantages of this art are the ability to secure a gap between the primary coil and secondary coil and the lack of need for intermediate parts such as spools, so the overall dimensions can be reduced. Further, the coil directly contacts the core, which is a metal material, so the cooling efficiency is also high.

In this regard, the ignition systems of gasoline engines have been evolving from configurations which distribute battery voltage boosted by an ignition coil to individual spark plugs by a distributor to electronic distribution systems which eliminate the distributors (distributor-less ignition systems). In a DLI system, there is no distributor, so the same number of ignition coils as the number of cylinders of the engine is necessary. Therefore, next, reduction of the space taken by this number of ignition coils in a DLI system has been sought.

To meet with this demand, in the past, a stick type ignition coil (fine diameter cylindrically shaped ignition coil) which makes effective use of the plug hole of an engine, in which a high tension cord connected to a spark plug used to be inserted, and fits in that plug hole has been developed (Japanese Patent Publication No. 11-111547 A1). A stick type ignition coil is comprised of a rod-shaped center core which is arranged at the center, a primary spool and a secondary spool made of plastic around which a primary coil and secondary coil are wound which are arranged around it, and an insulating material which is filled inside the housing. As the insulating material, to not only secure insulation, but also penetrate between the wires of the coils to prevent collapse of the wound coil shape or protect against damage due to vibration and considering also heat resistance, an epoxy resin, which is a heat curable insulating resin, has been used.

### SUMMARY OF THE INVENTION

In this regard, with the method of direct winding of the coils, there was the problem that when casting the metal material in a mold, shrinkage of the permeated epoxy resin due to curing caused breakage at the surfaces of the spools which were formed by plastic material and resulted in a decrease in the insulation characteristics. A similar problem arises in a stick type ignition coil. Shrinkage of the permeated epoxy resin due to curing caused breakage at the surfaces of the spools which were formed by plastic materials and lowered the insulation characteristics.

To deal with this problem, the outer circumference of the core has been covered by a shrink-fit tube to reduce the adhesion with the epoxy resin and improve the mold release. However, if covering the outer circumference of a core with a shrink-fit tube, there were the problems that since the tube had thickness, the outside diameter of the ignition coil increased, the shrink-fit tube could not exactly be fit to the outside shape of the core, and gaps ended up forming between the shrink-fit tube and core. Further, when covering the outer circumference of the core by a shrink-fit tube, automation was difficult.

An object of the present invention, in view of the above problem, is to provide a method of production of an ignition coil which provides the ignition coil with a core which is treated on its surface so as to form a mold release film which enables reduction of the adhesion with an epoxy resin and an ignition coil which is produced by that method of production.

To solve the above problem, the present invention comprises using a metal to form a rod-shaped center core, dipping the formed center core in a liquid UV curing resin, raising the center core from the liquid and shaking off the excess UV curing resin, irradiating the center core with UV rays to cause the UV curing resin which is deposited on the center core to cure and form an insulating film, attaching a first spool to the outside of the insulating film and winding a secondary coil over it, attaching a second spool to the outside of the secondary coil and winding a primary coil over it, inserting these into a case, then injecting an insulating material into the case to thereby produce an ignition coil.

For the insulating film, a material which cures at a humidity of 25° C.×55±5% or by irradiation by UV rays of a strength of 40 to 70 mW/cm² can be used. Further, the insulating film should be irradiated with UV rays for a predetermined time to give an adhesive strength with the insulating material of not more than 1 MPa. As the UV curing resin, a UV ray curing silicone resin may be used, while as the insulating material, an epoxy resin may be used.

The thus produced ignition coil may be made one with an adhesion between the insulating film which is provided at the outer circumference of the center core and the insulating material which is filled at the inside of the ignition coil of not more than a predetermined value. Even if the insulating material shrinks, there is little breakage at the surfaces of the spools which are formed by plastic materials and the insulation characteristics can be maintained. Further, compared with the measure of covering the outer circumference of the core with a shrink-fit tube to reduce the adhesion with the insulating material, it is possible to make the insulating film thinner and eliminate the obstacle to automation of production of the ignition coil.

### BRIEF DESCRIPTION OF THE DRAWINGS

These and other objects and features of the present invention will become clearer from the following description of the preferred embodiments given with reference to the attached drawings.

FIG. 1A is a process diagram which explains a method of production of an ignition coil of the present invention and shows the step of using a metal to form a rod-shaped center core.

FIG. 1B is a view which shows a step of dipping the center core which was formed at the step of FIG. 1A in a liquid UV curing resin.

FIG. 1C is a view which shows a step of raising the center core which was dipped in the liquid UV curing resin in the step of FIG. 1B from the liquid and shaking off the excess UV curing resin.

FIG. 1D is a view which shows a step of irradiating the center core from which excess UV curing resin was shaken off in the step of FIG. 1C with UV rays to cause the curing resin which is deposited on the center core to cure and form an insulating film.

FIG. 1E is a view which shows a step of attaching a first spool to the outside of the insulating film of the center core.

FIG. 1F is a view which shows a step of winding a secondary coil over the first spool which was attached to the outside of the insulating film of the center core.

FIG. 1G is a view which shows a step of attaching a second spool to the outside of the secondary coil which was wound at the step of FIG. 1F.

FIG. 1H is a view which shows a step of winding a primary coil over the second spool which was attached to the outside of the secondary coil.

FIG. 1I is a view which shows a step of inserting the center core around which the primary coil has been wound into a case, then injecting an insulating material into the case to complete the ignition coil.

FIG. 2 is a cross-sectional view which shows the state where a stick type ignition coil which is provided with the ignition coil which was produced by the steps which are shown in FIG. 1A to FIG. 1I is attached to a cylinder head of an engine.

FIG. 3 is a cross-sectional view along the line A-A of the stick type ignition coil which is shown in FIG. 2.

FIG. 4A is a perspective view which shows the insulating film which is covered over the center core of the ignition coil which is produced by the method of production of the present invention and a simple configuration for testing the adhesive strength between this insulating film and the insulating material.

FIG. 4B is a view which shows the test results of the adhesive strength between the insulating film and the insulating material when changing the thickness of the insulating film, the irradiation time of UV rays, and the humidity in the sample which is shown in FIG. 4A.

FIG. 5A is a view which shows the test results of the adhesive strength between the insulating film and the insulating material when changing the strength of the UV rays, the irradiation time of UV rays, and the thickness of the insulating film in the sample which is shown in FIG. 4A.

FIG. 5B is a view which shows the test results of the adhesive strength between the insulating film and the insulating material when changing the humidity, temperature, standing time, and thickness of the insulating film in the sample which is shown in FIG. 4A.

### DESCRIPTION OF THE PREFERRED EMBODIMENTS

While the invention has been described by reference to specific embodiments chosen for purposes of illustration, it should be apparent that numerous modifications could be made thereto by those skilled in the art without departing from the basic concept and scope of the invention.

The present invention may be more fully understood from the description of preferred embodiments of the invention, as set forth below, together with the accompanying drawings.

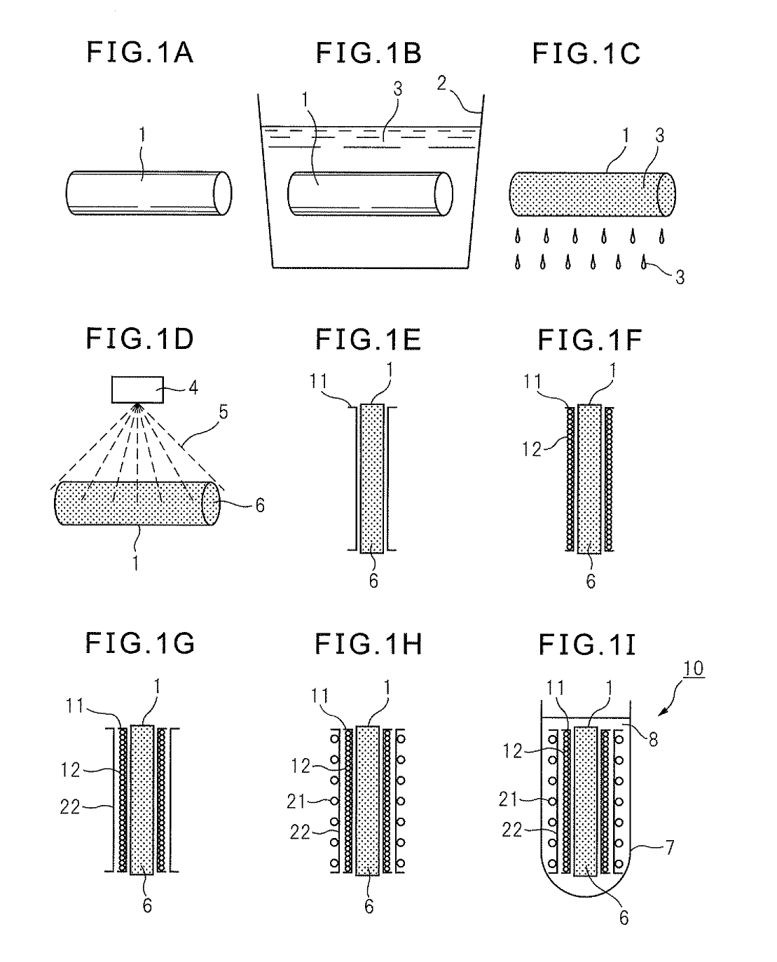

FIG. 1A to FIG. 1I are process diagrams for explaining a method of production of an ignition coil of the present invention. FIG. 1A is a view which shows a step of using a metal to form a rod-shaped center core 1. The center core 1 is generally produced by stacking thin silicon steel sheets in a direction perpendicular to the axial direction of the center core 1. The center core 1 of this embodiment is cylindrical in shape, but may also be prismatic in shape.

FIG. 1B is a view which shows a step of dipping the center core 1 which was formed at the step of FIG. 1A in a liquid UV curing resin 3 which is filled in a container 2. The UV curing resin 3 for example may be a UV curing silicone resin. Further, as the type of the silicone resin, a silicone resin called a “polysiloxane” may be used. “Polysiloxane” is the general name for silicone with an alkoxy group attached, that is, (RO)₄Si, siloxane with an alkoxy group attached, that is, (RO)₃Si-Si(RO)₃, and trisiloxane, tetrasiloxane, etc. with an alkoxy group attached, where R may be any organic group. As examples, there are dimethylsiloxane and trimethylsiloxane. In the examples, dimethylsiloxane is used. By irradiating the silicone resin with UV rays to cause it to cure, sagging at the time of melting (fall in edge properties) can be suppressed.

FIG. 1C is a view which shows a step of raising the center core 1 which was dipped in the liquid UV curing resin 3 in the step of FIG. 1B from the liquid and shaking off the excess UV curing resin 3. If raising the center core 1 which had been dipped in the liquid UV curing resin 3 from the liquid and immediately irradiating it with UV rays, unevenness would occur in the thickness of the insulating film which is formed at the outer circumference of the center core 1, so this step is necessary. In FIG. 1C, the surface of the center core 1 is shown with shading to indicate the deposition of UV curing resin 3. In the subsequent figures, the cases where the surface of the center core 1 has UV curing resin 3 or the UV curing resin 3 cured to form an insulating film 6 is shown with such shading.

FIG. 1D is a view which shows a step of irradiating the center core 1 from which excess UV curing resin 3 was shaken off in the step of FIG. 1C with UV rays 5 from a UV ray irradiation device 4 to cause the UV curing resin 3 which is deposited on the center core 1 to cure and form an insulating film 6. The irradiation time of the UV rays 5 from the UV ray irradiating device 4 is made a time whereby the adhesive strength between the insulating film 6 which is formed on the surface of the center core 1 and the insulating material which is provided on the insulating film 6 in a subsequent step becomes not more than 1 MPa. The adhesive strength between the insulating film 6 and the insulating material corresponding to the irradiation time of the UV rays 5 will be explained later.

After the surface of the center core 1 is formed with the insulating film 6 at the step of FIG. 1D, as shown in FIG. 1E, a first spool 11 is attached to the outside of the insulating film 6 of the center core 1. The first spool 11 is a frame for winding the secondary coil and is formed by a plastic. Next, as shown in FIG. 1F, the secondary coil 12 is wound over the first spool 11. The secondary coil 12 is for raising the 12V battery voltage to a 30 kV or more high voltage and is wound over the first spool 11 by at least 15000 turns.

FIG. 1G is a view which shows a step of attaching a second spool 22 to the outside of the secondary coil 12 which was wound over the first spool 11 at the step of FIG. 1F. The second spool 22 is a frame for winding the primary coil 21 and is formed by a plastic. Next, as shown in FIG. 1H, the primary coil 21 is wound over the second spool 22. The number of turns of the primary coil 21 is smaller than the secondary coil 12, so the wire size may be made greater.

FIG. 1I is a view which shows a step of inserting the center core 1 around which the secondary coil 12 and the primary coil 21 have been wound around the center core 1 into a case 7, then injecting an insulating material 9 into the case 7 to complete the ignition coil 10. As the insulating material 8, an epoxy resin 8 may be used. Note that, the shape of the case 7 which is shown in FIG. 1I is only for explaining the process of production of the ignition coil 10 and does not show the shape of an actual case 7. Due to the above steps, an ignition coil 10 which is provided with a center core 1 on which an insulating film 6 is formed as a mold release film which enables reduction of the adhesion with the insulating material 8, that is, the epoxy resin 8, is produced.

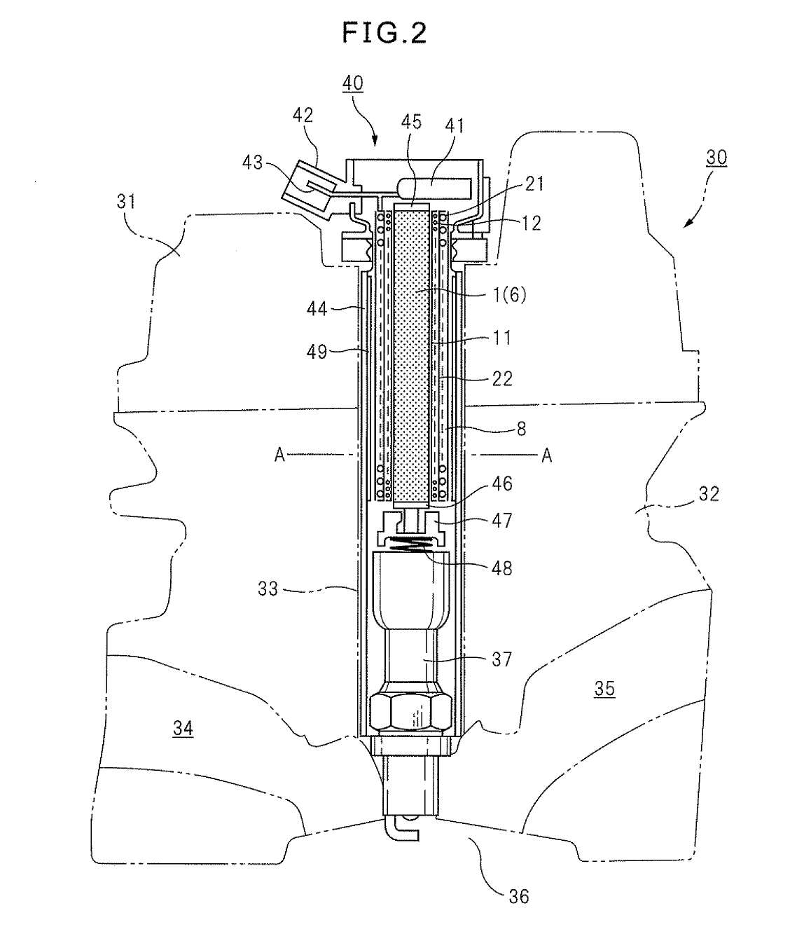

FIG. 2 is a cross-sectional view which shows the state with a stick type ignition coil 40 provided with an ignition coil which is produced by the steps which are shown in FIG. 1A to FIG. 1I attached to a cylinder head 32 of an engine 30. The stick type ignition coil 40 is a rod-shaped ignition coil which is fit into a plug hole 33 directly above a spark plug 37 which is attached to the cylinder head 32 of the engine 30. The cylinder head 32 of the engine 30 is provided with a spark plug 37 which ignites the air-fuel mixture of gasoline and air which is introduced into the combustion chamber 36 to which an intake port 34 and an exhaust port 35 are connected. The inside diameter of the mounting hole of the spark plug 37, that is, the plug hole 33, is φ23 as a standard. Therefore, the outside diameter of the stick type ignition coil 40 is not more than the inside diameter of the plug hole 33.

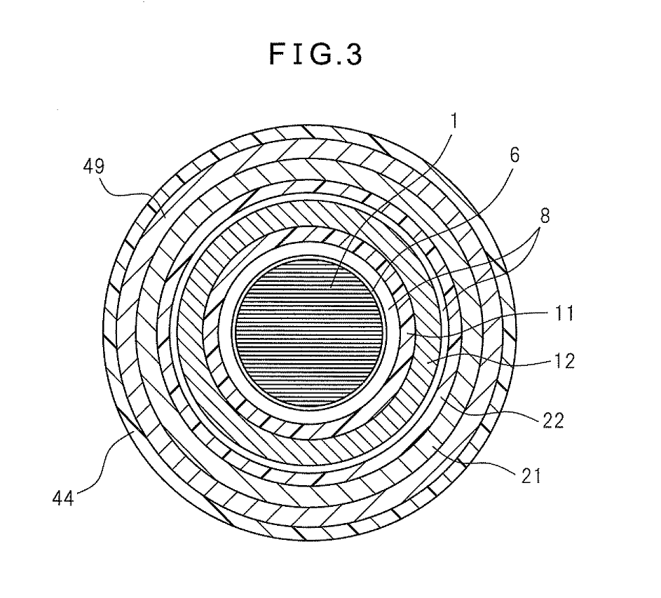

The plug hole 33 passes through the head cover 31 which is attached to the cylinder head 32 and opens to the outside, so the stick type ignition coil 40 is inserted into the plug hole 33 and connected to the spark plug 37. In the structure of the stick type ignition coil 40, as shown by the cross-section of line A-A of FIG. 2 in FIG. 3, magnetic circuit parts are arranged concentrically with a φ23 round cross-section. The magnetic circuit parts include, from the center side, the center core 1 which is covered by the insulating film 6, the secondary coil 12 which is wound around the first spool 11, and the primary coil 21 which is wound around the second spool 22. The magnetic circuit parts are contained inside the plastic housing 44 inside of which the insulating material (epoxy resin) 8 is filled. The insulating material 8 is filled by vacuum injection.

At the top of the stick type ignition coil 40, a small-size igniter 41 is provided which electronically controls the ignition timing. Similarly, the igniter 41 is connected to an input terminal 43 inside of a connector 42 which is provided at the top of the stick type ignition coil 40. At the two ends of the center core 1, there are permanent magnets 45, 46. These permanent magnets 45, 46 are attached with opposite polarities to the excitation pole of the center core. The primary coil 21 is made using insulated coil wire and is thicker than the coil wire of the secondary coil 12 and is electrically connected to the input terminal 43. The secondary coil 12 is made using very fine insulated coil wire and is electrically connected to a high voltage terminal 47. The high voltage terminal 47 is connected through a spring 48 to the spark plug 37. The outer core 49 is comprised of thin silicon steel sheet rolled into a tubular shape so as to form slits for insulation at the start and end. The role of the outer core 49 is to form a magnetic circuit as a set with the center core.

The insulating material 8 is vacuum injected whereby it enters the gaps inside the housing 44 to which the members are attached so as to secure electrical insulation between the members and fasten the members to protect against breakage, cracks, or other damage due to vibration. As explained above, as the insulating material 8, an epoxy resin, which satisfies the requirements of insulation ability, fastening strength, and heat resistance, is used. On the other hand, if using an epoxy resin as the insulating material 8, cold-heat distortion of the first spool 11 becomes maximum, so in the past, a resin film had been used as a mold release film at the center core 1 to prevent breakage of the members around the center core 1. However, in the present invention, an insulating film 6 which is formed by a UV curing resin is used, so it is possible to reduce the adhesion with the epoxy resin 8 and prevent breakage of members around the center core 1.

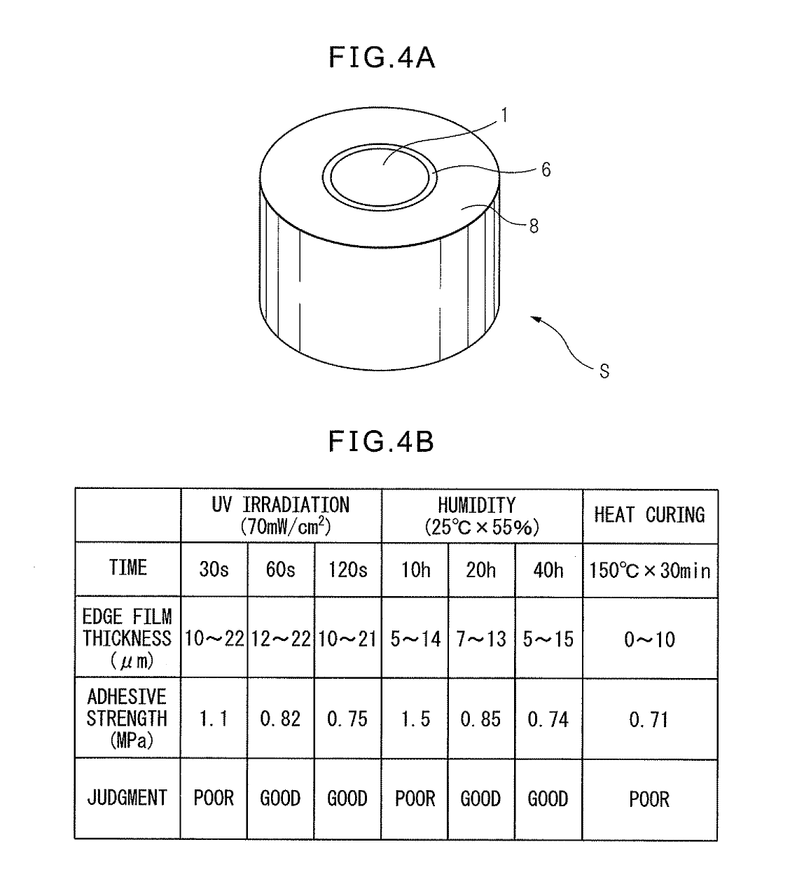

Here, the irradiation time of the UV rays 5 in the step of irradiating the UV curing resin 3 which is deposited at the center core 1 by UV rays 5 as explained in FIG. 1D will be explained. The inventors made samples S comprised of center cores 1 over which insulating films 6 were formed and at the outer circumferences of which insulating materials such as shown in FIG. 4A were laminated according to the method of production of the present invention and changed the conditions to test the adhesive strength between the insulating film 6 and insulating material 8. The results are shown in FIG. 4B. The inventors irradiated UV rays (UV) at a strength of 70 mW/cm² for changed times, left the samples standing at humidities of 25° .×55% for changed times, and formed an insulating film by heat curing for comparison as well. The edge film thickness is the thickness of the insulating film 6.

30 seconds of UV irradiation was not enough for making the adhesive strength 1 MPa. 60 seconds or 120 seconds was good. Further, when making the humidity 25° C.×55%, 10 hours were not enough for making the adhesive strength 1 MPa. 20 hours or 40 hours were necessary. Further, with heat curing, the film thickness became insufficient and good results were not obtained. Accordingly, to make an insulating film 6 with a low adhesion with the epoxy resin 8, it was learned that at least 60 seconds of UV irradiation or at least 20 hours under 25° C.×55% humidity conditions is necessary.

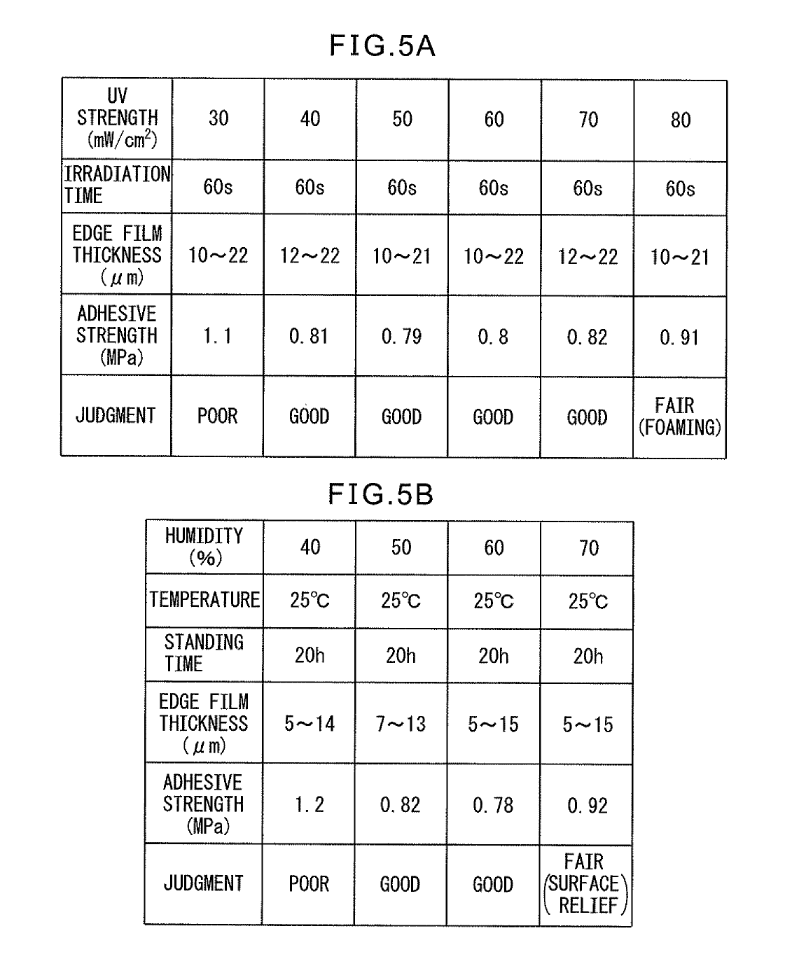

FIG. 5A shows the test results of the adhesive strength between the insulating film and the insulating material when changing the strength of the UV rays, irradiation time of the UV rays, and thickness of the insulating film in the samples S which are shown in FIG. 4A. Further, FIG. 5B shows the test results of the adhesive strength between the insulating film and the insulating material when changing the humidity, temperature, standing time, and thickness of the insulating film in the samples S which are shown in FIG. 4A.

As will be understood from the test results which are shown in FIG. 5A, with a UV ray strength (UV strength) of 30 mW/cm², the adhesive strength exceeds 1 MPa and is thereby unsatisfactory, while with 80 mW/cm², foaming occurs and the result is defective. Accordingly, it was learned that the conditions for obtaining a suitable adhesive strength were a UV ray strength of 40 to 70 mW/cm². Further, as will be understood from the test results which are shown in FIG. 5B, when changing the humidity under a state of a temperature of 25° C. and allowing the sample S to stand for 20 hours, the adhesive strength becomes unsatisfactory at humidities of 50% and 60%. With a humidity of 40%, the adhesive strength is unsatisfactory, while with a humidity of 70%, there is adhesive strength, relief shapes are seen on the adhered surfaces due to condensation, the adhesive strength is near 1 MPa, and therefore there is no extra leeway in terms of mold release and good results cannot be obtained. As a result, it was learned that to obtain suitable adhesive strength, the humidity conditions are 25° C.×55±5%.

What is claimed is:

1. A method of production of an ignition coil comprising
using a metal to form a rod-shaped center core,
dipping the formed center core in a liquid UV curing resin,
raising the center core from the liquid and shaking off the excess UV curing resin,
irradiating the center core with UV rays to cause the UV curing resin which is deposited on the center core to cure and form an insulating film,
attaching a first spool to the outside of the insulating film and winding a secondary coil over it,
attaching a second spool to the outside of the secondary coil and winding a primary coil over it,
inserting these into a case, then injecting an insulating material into the case to thereby produce an ignition coil.

2. The method of production of an ignition coil as set forth in claim 1, wherein said insulating film (6) is made from a material which cures at a humidity of 25° C.×55±5% or by irradiation by UV rays of a strength of 40 to 70 mW/cm².

3. The method of production of an ignition coil as set forth in claim 2, wherein said insulating film is irradiated by said UV rays for a predetermined time so that an adhesive strength with said insulating material (8) becomes not more than 1 MPa.

4. The method of production of an ignition coil as set forth in claim 3, wherein said predetermined time is 60 seconds or more.

5. The method of production of an ignition coil as set forth in claim 2, wherein said insulating film (6) is kept at said humidity for a predetermined time so that an adhesive strength with said insulating material (8) becomes not more than 1 MPa.

6. The method of production of an ignition coil as set forth in claim 5, wherein said predetermined time is 20 hours or more.

7. The method of production of an ignition coil as set forth in claim 1, wherein said UV curing resin is a UV curing silicone resin.

8. The method of production of an ignition coil as set forth in claim 2, wherein said UV curing resin is a UV curing silicone resin.

9. The method of production of an ignition coil as set forth in claim 3, wherein said UV curing resin is a UV curing silicone resin.

10. The method of production of an ignition coil as set forth in claim 4, wherein said UV curing resin is a UV curing silicone resin.

11. The method of production of an ignition coil as set forth in claim 5, wherein said UV curing resin is a UV curing silicone resin.

12. The method of production of an ignition coil as set forth in claim 6, wherein said UV curing resin is a UV curing silicone resin.

13. The method of production of an ignition coil as set forth in claim 1, wherein said insulating material is an epoxy resin.

14. The method of production of an ignition coil as set forth in claim 2, wherein said insulating material is an epoxy resin.

15. The method of production of an ignition coil as set forth in claim 3, wherein said insulating material is an epoxy resin.

16. The method of production of an ignition coil as set forth in claim 4, wherein said insulating material is an epoxy resin.

17. The method of production of an ignition coil as set forth in claim 5, wherein said insulating material is an epoxy resin.

18. The method of production of an ignition coil as set forth in claim 6, wherein said insulating material is an epoxy resin.

19. An ignition coil which is produced by
using a metal to form a rod-shaped center core,
dipping the formed center core in a liquid UV curing resin,
raising the center core from the liquid and shaking off the excess UV curing resin,
irradiating the center core with UV rays to cause the UV curing resin which is deposited on the center core to cure and form an insulating film,
attaching a first spool to the outside of the insulating film and winding a secondary coil over it,
attaching a second spool to the outside of the secondary coil and winding a primary coil over it,
inserting these into a case, then injecting an insulating material into the case.
